(19) United States
(12) Patent Application Publication
(10) Pub. No.: US 2021/0166192 A1
(43) Pub. Date: Jun. 3, 2021

(54) ITEM SHIPMENT FOR PASSENGERS

(71) Applicant: FORD GLOBAL TECHNOLOGIES, LLC, Dearborn, MI (US)

(72) Inventor: Alexander BALVA, Palo Alto, CA (US)

(21) Appl. No.: 17/047,909

(22) PCT Filed: Apr. 16, 2018
(86) PCT No.: PCT/US2018/027779

§ 371 Date: Oct. 15, 2020

(51) Int. Cl. G06Q 10/08; G06Q 50/30; G07C 9/00

(52) U.S. Cl. CPC G06Q 10/08355; G06Q 10/0834; B60W 60/00253; G06Q 10/0836; G07C 9/00563; G06Q 50/30

(57) ABSTRACT

A transit service can deliver an item to a passenger or receive an item for delivery from a passenger. The transit service can receive an item, a request to deliver the item to a passenger, and a request from the passenger for a trip. The transit service can perform an objective function to determine an optimal vehicle to deliver the item to the passenger. The objective function can consider capacities of vehicles, characteristics of the item, and rider preferences. The transit service can track items, vehicles, and passengers to coordinate delivery. The transit service can secure the item and disengage a security mechanism based on the locations of the item, respective vehicle, and respective passenger.

### BACKGROUND

People are increasingly turning to delivery services to receive purchased goods. However, aligning recipient availability with item delivery is difficult to schedule. Conventional delivery services might leave items at the recipient's home but this method cannot verify actual receipt of the item and can leave the item susceptible to theft. Conventional delivery services, upon not finding the recipient at home might try again at another time, which consumes extra fuel and time of the driver. Even when the delivery service is able to catch the recipient at home, the delivery service might need to wait for the recipient to come to the door which increases the amount of time a delivery takes. Furthermore, these conventional approaches typically require the recipient to be cognizant of delivery windows and receiving the item can be a disruption to the recipient's schedule or activities.

### BRIEF DESCRIPTION OF THE DRAWINGS

Various embodiments in accordance with the present disclosure will be described with reference to the drawings, in which:

FIG. 1A illustrates an example ride request environment in which various embodiments can be implemented.

FIG. 1B illustrates an example vehicle for transporting passengers and vehicles in accordance with various embodiments.

FIG. 2 illustrates an example process for delivering an item to a passenger that can be utilized in accordance with various embodiments.

FIG. 3 illustrates an example process for selecting an optimal vehicle for providing an item to a passenger that can be utilized in accordance with various embodiments.

FIG. 4 illustrates an example process for receiving an item from a passenger that can be utilized in accordance with various embodiments.

FIGS. 5A, 5B, and 5C illustrate example trips and techniques for delivering an item to a passenger in accordance with various embodiments.

FIGS. 6A, 6B, and 6C illustrate example techniques for delivering an item to a seat for a passenger in accordance with various embodiments.

FIG. 7 illustrates an example operation of a portable electronic device to scan and receive an item in accordance with various embodiments.

FIG. 8 illustrates an example vehicle layout for putting passengers and items into a vehicle in accordance with various embodiments.

FIG. 9 illustrates an example trip request screen on a personal electronic device in accordance with various embodiments.

FIG. 10 illustrates an example computing device that can be utilized to submit trip requests and receive route options in accordance with various embodiments.

FIG. 11 illustrates example components of a computing device that can be utilized to implement aspects of the various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches described and suggested herein relate to delivering an item to a passenger and/or receiving an item from a passenger while the passenger uses a transit service. In particular, various embodiments provide approaches for receiving an item (or group of items), a delivery request to deliver the item to a passenger, and a trip request for the passenger. The item can be a meal, package, letter, personal transportation device, or other object. A transit service can utilize an objective function to balance various metrics when selecting between available vehicles that can be used to deliver the item to the passenger. The objective function can provide a compromise between, for example, vehicle capacities, how full certain vehicles are expected to be, item characteristics, passenger preferences, and trip characteristics, such as whether transfers are involved. The transportation service can monitor locations of items, passenger, and vehicles and coordinate delivery based on colocation of a passenger with the respective item. Delivering an item can include verifying delivery and requiring a signature. The transit service can engage a security mechanism when the item is placed in the vehicle and disengage the security mechanism when the item is provided to the passenger. The transit service can provide the item to the passenger when the transit service determines that that passenger is at the origin of the trip, the destination of the trip, a transfer point of the trip, or anywhere in between.

Various other such functions can be used as well within the scope of the various embodiments as would be apparent to one of ordinary skill in the art in light of the teachings and suggestions contained herein.

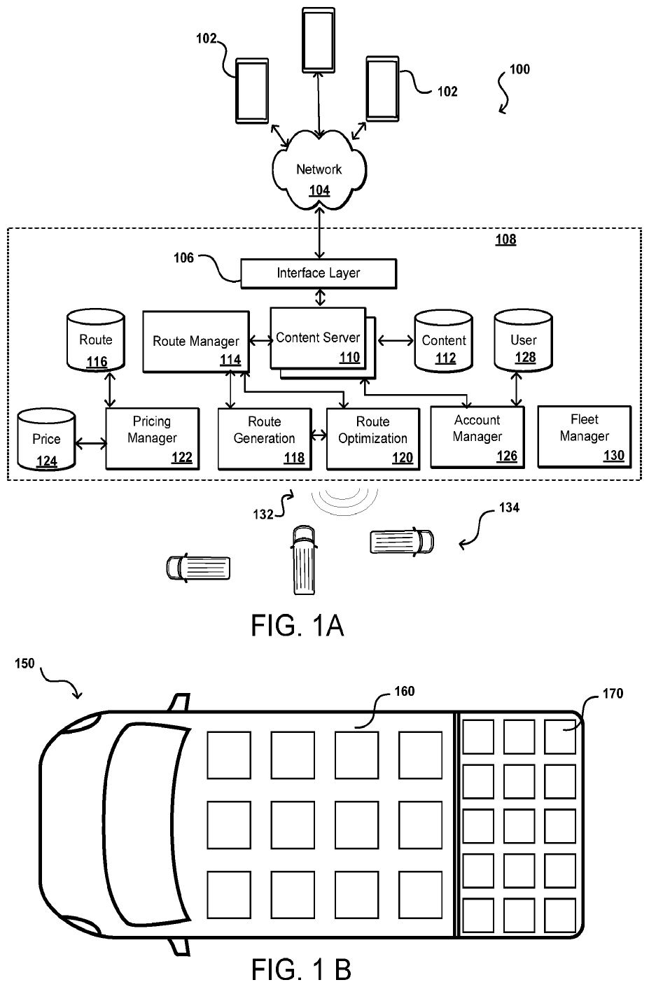

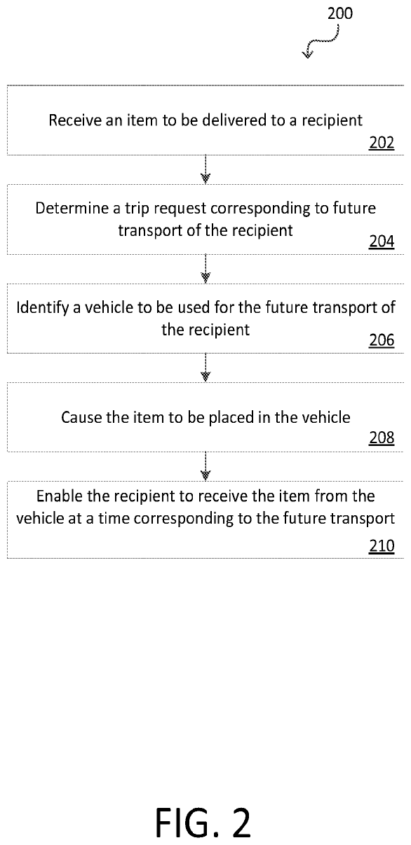

FIG. 1A illustrates an example system 100 that can be utilized to determine and manage vehicle routing in accordance with various embodiments. In this system, various users can use applications executing on various types of computing devices 102 to submit route requests over at least one network 104 to be received by an interface layer 106 of a service provider environment 108. The computing devices can be any appropriate devices known or used for submitting electronic requests, as may include desktop computers, notebook computers, smartphones, tablet computers, and wearable computers, among other such options. The network(s) can include any appropriate network for transmitting the request, as may include any selection or combination of public and private networks using wired or wireless connections, such as the Internet, a cellular data connection, a WiFi connection, a local area network connection (LAN), and the like. The service provider environment can include any resources known or used for receiving and processing electronic requests, as may include various computer servers, data servers, and network infrastructure as discussed elsewhere herein. The interface layer can include interfaces (such as application programming interfaces), routers, load balancers, and other components useful for receiving and routing requests or other communications received to the service provider environment. The interfaces, and content to be displayed through those interfaces, can be provided using one or more content servers capable of serving content (such as web pages or map tiles) stored in a content repository 112 or other such location.

Information for the request can be directed to a route manager 114, such as may include code executing on one or more computing resources, configured to manage aspects of routes to be provided using various vehicles of a vehicle pool or fleet associated with the transport service. The route manager can analyze information for the request, determine available planned routes from a route data store 116 that have capacity and match the criteria of the request, and can provide one or more options back to the corresponding device 102 for selection by the potential rider. The appropriate routes to suggest can be based upon various factors, such as proximity to the origination and destination locations of the request, availability within a determined time window, and the like. In some embodiments there may be other factors considered as well as discussed herein, such as the cost or limitations on various route or vehicle options. For example, in some jurisdictions any vehicle that has fixed or convertible seating that can seat at least ten passengers is considered a commercial vehicle and may require special licensing and have various applicable limitations. Accordingly, it may be desirable to utilize vehicles that can seat only up to nine human passengers, with a remainder being allocated as capacity for packages or other items from transport. This can also allow for the use of larger non-commercial vehicles, which can help to reduce operational costs and improve profitability of at least some route options. In some embodiments, an application on a client device 102 may instead present the available options from which a user can select, and the request can instead involve obtaining a seat for a specific planned route at a particular planned time.

As mentioned, however, in some embodiments users can either suggest route information or provide information that corresponds to a route that would be desired by the user. This can include, for example, an origination location, a destination location, a desired pickup time, and a desired drop-off time. Other values can be provided as well, as may relate to a maximum duration or trip length, maximum number of stops, allowable deviations, and the like. In some embodiments at least some of these values may have maximum or minimum values, or allowable ranges, specified by one or more route criteria. There can also be various rules or policies in place that dictate how these values are allowed to change with various circumstances or situations, such as for specific types of users or locations. The route manager 114 can receive several such requests, and can attempt to determine the best selection of routes to satisfy the various requests. In this example the route manager can work with a route generation module 118 that can take the inputs from the various requests and provide a set of route options that can satisfy those requests. This can include options with different numbers of vehicles, different vehicle selections or placements, and different options for getting the various customers to their approximate destinations at or near the desired times. It should be understood that in some embodiments customers may also request for specific locations and times where deviation is not permissible, and the route manager may need to either determine an acceptable routing option or deny that request if minimum criteria are not met. In some embodiments an option can be provided for each request, and a pricing manager 122 can determine the cost for a specific request using pricing data and guidelines from a price repository 124, which the user can then accept or reject.

In this example, the route generation module 118 can generate a set of routing options based on the received requests for a specified area over a specified period of time. A route optimization module 120 can perform an optimization process using the provided routing options to determine an appropriate set of routes to provide in response to the various requests. Such an optimization can be performed for each received request, in a dynamic routing system, or for a batch of requests, where users submit requests and then receive routing options at a later time. This may be useful for situations where the vehicle service attempts to have at least a minimum occupancy of vehicles or wants to provide the user with certainty regarding the route, which may require a quorum of riders for each specific planned route in some embodiments. In various embodiments an objective function is applied to each potential route in order to generate a route “quality” score, or other such value. The values of the various options can then be analyzed to determine the routing options to select. In one embodiment, the route optimization module 120 applies the objective function to determine the route quality scores and then can select the set of options that provides the highest overall, or highest average, total quality score. Various other approaches can be used as well as would be understood to one of ordinary skill in the art in light of the teachings and suggestions contained herein.

In at least some embodiments, the objective function can be implemented independent of a particular implementation of an optimization algorithm. Such an approach can enable the function to be used as a comparative metric of different approaches based on specific inputs. Further, such an approach enables various optimization algorithms to be utilized that can apply different optimization approaches to the various routing options to attempt to develop additional routing options and potential solutions, which can help to not only improve efficiency but can also potentially provide additional insight into the various options and their impact or interrelations. In some embodiments an optimization console can be utilized that displays the results of various optimization algorithms, and enables a user to compare the various results and factors in an attempt to determine the solution to implement, which may not necessarily provide the best overall score. For example, there might be minimum values or maximum values of various factors that are acceptable, or a provider might set specific values or targets on various factors, and look at the impact on the overall value and select options based on the outcome. In some embodiments the user can view the results of the objective function as well, before any optimization is applied, in order to view the impact of various factor changes on the overall score. Such an approach also enables a user or provider to test new optimization algorithms before selecting or implementing them, in order to determine the predicted performance and flexibility with respect to existing algorithms.

Further, such an approach enables algorithms to evolve automatically over time, as may be done using random experimentation or based on various heuristics. As these algorithms evolve, the value of the objective function can serve as a measure of fitness or value of a new generation of algorithms. Algorithms can change over time as the service areas and ridership demands change, as well as to improve given the same or similar conditions. Such an approach may also be used to anticipate future changes and their impact on the service, as well as how the various factors will change. This can help to determine the need to add more vehicles, reposition parking locations, etc.

In some embodiments artificial intelligence-inclusive approaches, such as those that utilize machine learning, can be used with the optimization algorithms to further improve the performance over time. For example, the raising and lowering of various factors may result in a change in ridership levels, customer reviews, and the like, as well as actual costs and timing, for example, which can be fed back into a machine learning algorithm to learn the appropriate weightings, values, ranges, or factors to be used with an optimization function. In some embodiments the optimization function itself may be produced by a machine learning process that takes into account the various factors and historical information to generate an appropriate function and evolve that function over time based upon more recent result and feedback data, as the machine learning model is further trained and able to develop and recognize new relationships.

Various pricing methods can be used in accordance with the various embodiments, and in at least some embodiments the pricing can be used as a metric for the optimization. For example, the cost factors in some embodiments can be evaluated in combination with one or more revenue or profitability factors. For example, a first ride option might have a higher cost than a second ride option, but might also be able to recognize higher revenue and generate higher satisfaction. Certain routes for dedicated users with few to no intermediate stops might have a relatively high cost per rider, but those riders might be willing to pay a premium for the service. Similarly, the rider experience values generated may be higher as a result. Thus, the fact that this ride option has a higher cost should not necessarily have it determined to be a lower value option than others with lower cost but also lower revenue. In some embodiments there can be pricing parameters and options that are factored into the objective function and optimization algorithms as well. Various pricing algorithms may exist that determine how much a route option would need to have charged to the individual riders. The pricing can be balanced with consumer satisfaction and willingness to pay those rates, among other such factors. The pricing can also take into various other factors as well, such as tokens, credits, discounts, monthly ride passes, and the like. In some embodiments there might also be different types of riders, such as customer who pay a base rate and customers who pay a premium for a higher level of service. These various factors can be considered in the evaluation and optimization of the various route options.

FIG. 1B illustrates an example environment 150 in which aspects of the various embodiments can be implemented. The transportation can be provided using a vehicle 150 (or other object) capable of concurrently transporting one or more riders. While riders as used herein will often refer to human passengers, it should be understood that a “rider” in various embodiments can also refer to a non-human rider or passenger, as may include an animal or an inanimate object, such as a package for delivery. In this example, a rideshare service offers routes using at least one type of vehicle that includes space for a driver 102 and seats or other capacity for up to a maximum number of riders. It should be understood that various types of vehicles can be used with different numbers or configurations of capacity, and that autonomous vehicles without dedicated drivers can be utilized as well within the scope of the various embodiments. Vehicles such as smart bicycles or personal transport vehicles may be used as well, which may include seating capacity for only a single rider or limited number of passengers. For a given vehicle on a given route, a number of available seats 106 (or other rider locations) may be occupied by riders, while another number of seats 108 may be unoccupied. In some embodiments objects such as packages or deliveries may also occupy available space for a ride as well. In order to improve the economics of the rides offered, it can be desirable in at least some embodiments to have the occupancy as close to full as possible during the entire length of the trip. Such a situation results in very few unsold seats, which improves operational efficiency. One way to achieve high occupancy might be to offer only fixed routes where all passengers board at a fixed origination location and off-board at a fixed destination location, with no passengers onboarding or off-boarding at intermediate locations.

The vehicle can include a section for item storage 170 and a section for passengers 160. Some passengers might feel uncomfortable being seated with items for delivery, as passengers may feel like a parcel themselves; in order to minimize this, the section for passengers 160 and the section for items 170 can be visually separated. In some embodiments, the section for passengers 160 can be configurable to hold items as well. The section for item storage 170 can be a trunk, front storage area, overhead compartment, roof-mounted container, trailer, etc.

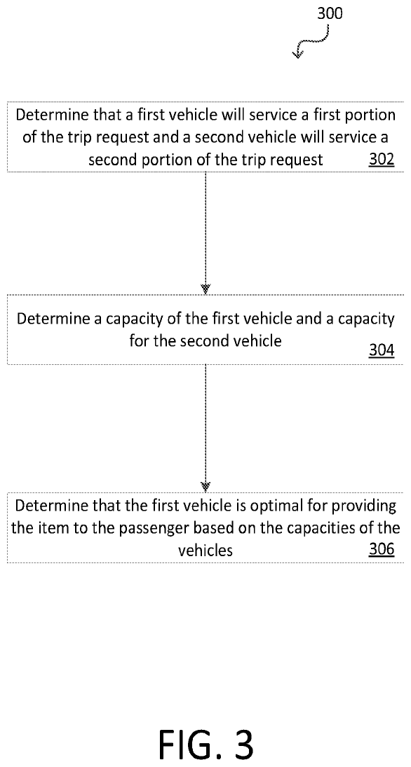

FIG. 2 illustrates an example process 200 for delivering an item to a passenger that can be utilized in accordance with various embodiments. It should be understood that, for this and other processes discussed herein, there can be additional, fewer, or alternative steps, performed in similar or alternative steps, or in parallel, within the scope of the various embodiments unless otherwise stated. In this example, a transit service can receive an item to be delivered to a recipient (or passenger) 202. For example, a delivery service can drop off the item at a transit hub operated by the transit service.

The item can be any item capable of being transported using approaches discussed here, including items such as a package, parcel, card, envelope, meal, personal transportation device (e.g., skateboard, longboard, scooter, bicycle, etc.), entertainment device, luggage, etc.

When the item is received, the transit service can identify the item and determine that it should be delivered to the passenger. The transit service can associate the item with the passenger by identifying the passenger's name on the item. Alternatively or additionally, the passenger or sender of the item can provide a code to the transit service effective to identify the item (and associate it with the passenger). For example, the passenger can supply a tracking number associated with the item to the transit service.

The transit service can receive a delivery request to deliver an item to the passenger. For example, when the passenger purchases something on an online retailer, the passenger can designate the delivery address as care of the transit service or otherwise instruct the online retailer to deliver using the transit service.

In some embodiments, the transit service generates the delivery request. For example, the transit service can sell items. The transit service can send items between passengers. For example, a passenger in the morning might wish to write a love letter to their significant other and have it delivered to the significant other later on. The transit service can coordinate a passenger delivering an item to his or herself. For example, the passenger can bring a suitcase as the passenger goes to work and then can have the suitcase delivered to his or herself as they travel from work to an airport. In some embodiments, the passenger generates the delivery request. For example, the passenger can instruct a delivery service (or retailer) to deliver an item to the transit service and the passenger can instruct the transit service to deliver the item to the passenger.

A transit service can determine a trip request corresponding to future transport of the recipient (or passenger) 204. For example, the passenger can request a trip using an application on a portable electronic device. As appropriate, the terms “recipient” and “passenger” can be interchangeable.

The transit service can provide vehicles for hire (e.g., a taxi or limousine service), a private transit service (e.g., a private bus route or a shuttle), a public transit service (e.g., a bus or train), a vehicle rental service, etc. Similarly, the vehicle as disclosed herein can be a car, bus, train, boat, airplane, etc. In some embodiments, a transit service in coordination with a delivery service can perform the principles disclosed herein. For example, a delivery service can receive trip request data and determine an opportunity to deliver items to passengers, instructing the transit service when to load items onto vehicles.

The trip request can be for a single ride. Additionally or alternatively, the trip request can be for a routine trip on the transit service. For example, the passenger can request or reserve a certain daily trip for their commute. The trip request can specify an origin, a destination, and a time (e.g., a departure or arrival time).

The transit service can identify a vehicle to be used for the future transport of the recipient (or passenger) 206. For example, the trip request can be serviced by a combination of two routes and a transfer, each of the two routes might be serviced by multiple vehicles at regular intervals. The trip request can include a departure time and the transit service can determine which vehicle(s) will service the trip request.

The vehicle can be any mode of transportation such as a car, bus, train, shuttle, tram, elevator, plane, boat, etc. The vehicle can be piloted or automated (e.g., “driverless”). The vehicle can be operated by the transit service or by some other party. In trips that require transfers between vehicles, the two or more vehicles need not be the same type or even operated by the same entity.

In some embodiments, the vehicle can service a route. A route can be predetermined and routine. A route can be dynamically generated based on current needs and capacities. The route can be generated to service one or more trip requests. The route can have designated pick-up/drop-off locations (“stops”). The trip request can specify an origin stop and a destination stop.

In some embodiments, the transit service receives, or expects to receive, multiple trip requests from a passenger. The transit service can then determine an optimal trip for delivering the item to the passenger. For example, the transit service can determine that trips are better for delivering the item to the passenger. Trips that are better for delivery can include ones that have a destination as the passenger's home while trips destined for a restaurant or a theater can be less desirable. Trips can be scored for delivery desirability based on a trip time, origin, destination (e.g., destination stop characteristics), or a combination thereof.

Some stops might have worse accessibility and can be less desirable, for example stops might be require taking a flight of stairs, have crowded platforms, or have full-height turnstiles. Some stops might have security concerns and passengers might prefer not carrying items at those stops. The transit service can score stops based on the respective stop's characteristics, passenger preferences, and item characteristics (e.g., size, weight, or how conspicuous the item is). In some embodiments, stops are disallowed for pick-up or drop-off. Similarly, certain stops can be designated item pick-up or drop-off capable.

The transit service can cause the item to be placed in the vehicle 208. Various locations can be appropriate for placing the item in the vehicle. For example, the item can be placed in the vehicle at a transit hub, a transfer location (e.g., from another vehicle or a storage locker), or any location along a route for the vehicle. The item can be placed in the vehicle long before the vehicle services the trip request such as at the beginning of the day or immediately prior to serving the trip request. The transit service can instruct a driver of the vehicle to retrieve the item and place it in the vehicle. The transit service can notify the passenger that the item has been placed in the vehicle.

The item can be placed on top of the vehicle, in a seat of the vehicle, in a locker in the vehicle, in a trunk of the vehicle, etc. A vehicle can be configurable. A vehicle can have a maximum passenger capacity, a minimum passenger capacity (e.g., based on fixed seats), a maximum item capacity (based on size and/or quantity of items), a minimum item capacity (e.g., based on trunk space or other space that can only be used for item storage), a maximum weight capacity, etc. Configuring the vehicle can adjust the various capacities for the vehicle. For example, seats can be removed or folded down, a trailer or roof-rack can be attached, etc. A configuration (or configuration element) can have a cost associated with it, such as a capital cost (e.g., adding a trailer), a fuel cost (e.g., adding a trailer or roof-rack), a comfort cost (e.g., a passenger may feel uncomfortable surrounded by packages), or a configuration time cost (e.g., the time it takes to modify the configuration element). The transit service can configure a vehicle based on the expected passenger count and item load for the vehicle. The transit service can reconfigure a vehicle every stop, trip, route, hour, day, etc. based on passenger and item requirements. In some embodiments, the transit service calculates an expected reconfiguration time and adjusts route timings accordingly. If reconfiguration at a certain location or time would interfere with route or trip time constraints, the transit service can attempt to not reconfigure at that location.

In some embodiments, placing the item in the vehicle includes engaging a security mechanism. The security mechanism can be a physical restraint such as a lock. The security mechanism can be an alarm that would alert passengers or the driver if the item is inappropriately removed or tempered with. For example, the security mechanism can include a camera monitoring an item and can detect when the item is removed. In some embodiments, the security mechanism is part of the vehicle, such as a trunk.

The security mechanism can be in communication with the transit service. In some embodiments, the transit service can be in communication with and track the locations of any of items, passengers, and vehicles. For example, a passenger can have a portable electronic device (e.g., cell phone, tablet, wearable device, etc.) that can indicate to the transit service the passenger's location. The transit service can then determine when to disengage the security mechanism based on a location of the vehicle (e.g., when the vehicle arrives at the passenger's origin or destination), a location of the passenger (e.g., when the passenger is near the item, based on a location from a personal electronic device associated with the passenger), an instruction from the passenger, etc. In some embodiments, the security mechanism can be deactivated using a code; the transit service can send the code to the passenger (or a driver) and the passenger (or driver) can provide the code to the security mechanism to disengage it. The code can include a QR code shown on a portable electronic device to a sensor on the security mechanism. In some embodiments, the security mechanism is integrated into the vehicle and the transit service has exclusive control over the security mechanism; for example, the security mechanism can be the trunk of the vehicle which the driver cannot unlock but then transit service can instruct the vehicle to disengage.

The transit service can enable the recipient (or passenger) to receive the item from the vehicle at a time corresponding to the future transport 210. For example, a driver of a vehicle can retrieve and deliver the item to the passenger. Alternatively, the passenger can retrieve the item without assistance. The transit service can provide the item to the passenger various delivery locations such as at the origin of the trip, the destination of the trip, or anywhere in between. For example, the driver can be instructed to hand the item to the passenger as the passenger enters or leaves the vehicle. In some embodiments, the passenger can retrieve the item while the vehicle is in motion (e.g., if the item is on a seat or in an overhead compartment). In order to minimize delays, the transit service can combine deliveries to multiples passengers. For example, the transit service can identify a location or stop where the transit service can provide multiple items to the respective passengers at one time. The transit service can choose a delivery location that minimizes total passenger delay. For example, if one passenger does not have an item while two passengers have items, the transit service can choose a delivery location where the one passenger without an item is not onboard.

The transit service can notify the driver or the passenger to deliver or receive the item based on the locations any of the item, the vehicle, and the passenger. Such a notification can include an unlock code or prompt to disengage the security. For example, the transit service can provide a reminder notification to the passenger to retrieve the item as the passenger leaves the vehicle. Similarly, the transit service can notify the driver to provide the item to the passenger as the passenger enters the vehicle.

Providing the item to the passenger can include delivery verification. For example, the passenger can authenticate delivery using a signature or biometric input (e.g., fingerprint, voiceprint, facial recognition, etc.). The passenger can provide delivery verification using a portable electronic device associated with the passenger. For example, an application associated with the transit service running on a passenger's phone can prompt the passenger to sign a box displayed within the application. Delivery verification can be transmitted to a delivery service that originated shipment of the item.

As stated previously, the steps of example method 200 can be performed in various combinations according to the principles disclosed herein.

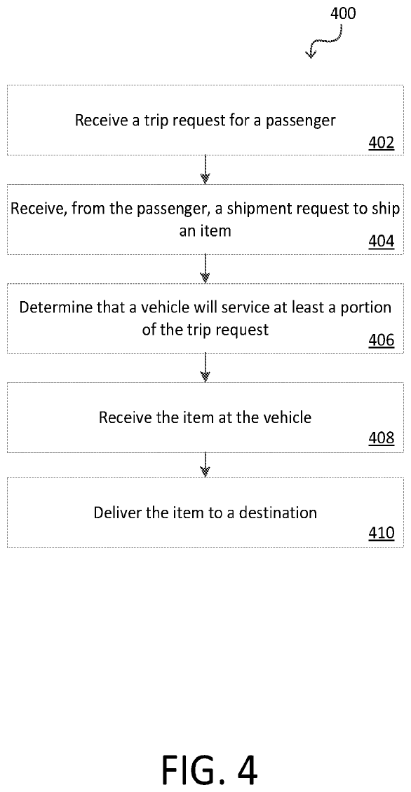

FIG. 3 illustrates an example process 300 for selecting an optimal vehicle for providing an item to a passenger when multiple vehicles can service different portions of a trip request. An objective function can be used. Inputs to the objective function are herein disclosed. The transit service can determine that a first vehicle will service a first portion of the trip request and a second vehicle will service a second portion of the trip request 302. For example, the passenger's trip can include a ride with the first vehicle and then a transfer to the second vehicle. More vehicles and transfers are contemplated. Some transfers include substantial delays or layovers.

The transit service can then determine a capacity of the first vehicle and a capacity of the second vehicle 304. As discussed previously, a capacity can include a passenger capacity, an item capacity, a weight capacity, etc. The capacity of a vehicle can be informed by passengers that are scheduled or expected to ride in the vehicle. Similarly, the capacity of a vehicle can be informed by items that are scheduled or expected to be loaded into the vehicle. The determined capacity can be based on a period of time. For example, if a vehicle is only able to load items once a day (e.g., in the morning at a transit hub), then the capacity can be determined based on the maximum concurrent ridership and item storage during the day. Alternatively, if the vehicle is able to retrieve items multiple times a day such as at a storage locker along a route for the vehicle, then the capacity can be determined based on the ridership or item store for the respective period.

The transit service can then determine that the first vehicle is optimal for providing the item to the passenger based on the capacities of the vehicles 306. It should be understood that the labels “first” and “second” are used for distinction and not to connote order. For example, the “first” vehicle can be the last vehicle servicing the passenger's trip.

Determining an optimal vehicle can be based on item characteristics. Many items can be carried with a person (e.g., on the person's lap) once they are delivered and thus do not necessarily need to be accounted for after delivery to the passenger. Alternatively, some items might not be too large to be carried by a person and so, even after being delivered to the passenger, an item might take still use up capacity of the vehicle. It would be desirable to deliver such large items using the final vehicle of a passenger's trip. An item's weight can be considered when determining an optimal vehicle. For example, the transit service can determine that a heavy item is best to deliver at the end of the passenger's trip to avoid carrying the extra weight with other vehicles.

The optimal vehicle can be determined based on an optimal delivery time. For example, if the item is a hot meal, the transit service can determine the length of time the meal can be stored before it cools off. The transit service can then determine a delivery window based on that length of time and can determine which vehicle or vehicles will be within that window. Similarly, an item can have time restrictions associated with it such as a guaranteed delivery window.

The optimal vehicle can be determined based on a number of transfers that the passenger would need to transport the item after receiving it. This can help minimize inconvenience for a passenger, especially with regards to items that do not transfer well. For example, a meal or large item. Characteristics of transfer(s) can also be considered. A transfer can have a long delay (e.g., a layover) which can be conducive to eating a meal. Alternatively, a transfer can be short and might require the passenger to rush between vehicles which might be less conducive to carrying the item. A transfer might include stairs, an elevator, require prolonged standing, be outside, have extreme temperatures, or have security concerns. All of these characteristics of a transfer can inform an optimal vehicle to provide the item to the passenger.

When determining an optimal vehicle to provide an item to a passenger, the transit service can use an objective function using the aforementioned considerations. The transit service can select an optimal vehicle based on other items that are to be delivered as well so as to maximize the combined score of all deliveries.

The above principles can be applied to any situation where two or more vehicles are available to carry the passenger. This may include determining an optimal route, routes, or timing for servicing the trip. In addition to the above scenario where two vehicles are servicing different portions of a trip, the two vehicles can service two different trips for the passenger. For example, a passenger might have requested a commute to work and a commute from work and the transit service can determine that a vehicle on the trip home is optimal based on the above considerations.

It should be understood that choosing an optimal vehicle need not assume that certain vehicles will definitely service the trip request. The an objective function for selecting a vehicle or vehicles to service the trip can also be the objective function to determine which vehicle or vehicles help deliver the item. In other words, servicing the trip can be dependent on delivery considerations, possibly choosing alternate routes or vehicles to service the trip to accommodate the delivery. In some embodiments, two vehicles can be available to service the same portion of the trip request but at different times; thus the transit service can determine that having the passenger wait for a later vehicle can be optimal (e.g., if the later vehicle has greater capacity). The transit service can factor wait times into the optimization algorithm. In some embodiments, various vehicles or routes are designated as passenger-only while others are designated as having item provisioning capacities.

If a passenger expects to take multiple trips in the future with the transit service, the passenger may prefer to delay receiving the item until a later trip. In some embodiments, the transit service allows the passenger to specify if they want to receive an item during a trip.

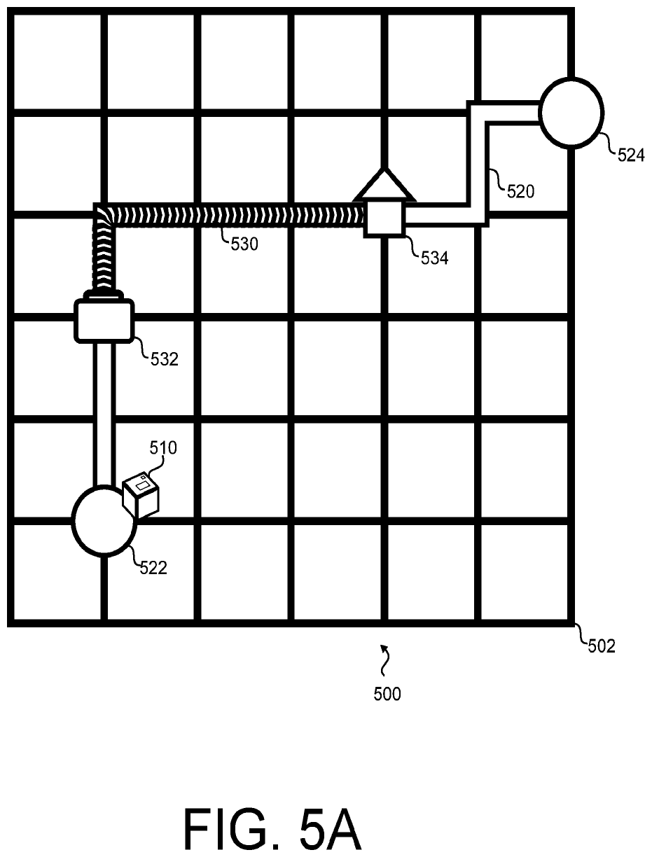

FIG. 4 illustrates an example process 400 for receiving an item from a passenger. For example, similar to using transit service to deliver an item (example process 200), a passenger can use the transit service to send or ship an item. The transit service can receive a trip request for a passenger 402 as disclosed with regards to step 204 of example process 200.

The transit service can receive, from the passenger, a shipment request to ship an item 404. For example, the passenger can, as part of their trip request, indicate item(s) that the passenger desires the transit service to take. The passenger can take a picture of the item. If the item has a shipping label, the passenger can scan the shipping label or otherwise provide data from the label to the transit service. The shipment request can include other information about the item, such as a destination, dimensions, contents, weight, etc. of the item.

The transit service can calculate a fee for the shipment. This can be calculated as part of the maximization function described above (e.g., based on the expected capacities of any associated vehicles). The transit service can provide shipment to a delivery service which can then provide shipment to the destination. The transit service can get a price quote from the delivery service and then add on a surcharge.

The transit service can determine that a vehicle will service at least a portion of the trip request 406 as disclosed with regards to step 206 of example process 200.

The transit service can receive the item at the vehicle 408. In some embodiments, the transit service receives the request to ship the item occurs at the vehicle. The vehicle can be equipped with technology and sensors to process the item. For example, the vehicle can have a scale to weigh the item. The vehicle can have equipment to scan the item or print a label for the item. Receiving the item can include engaging a security mechanism as discussed previously. Receiving the item can also include verifying the item or passenger using biometrics etc. as discussed above.

The transit service can then deliver the item to a destination 410. In some embodiments, the transit service delivers the item to a final destination. Alternatively, the transit service can deliver the item to another delivery service. In one example, if a passenger requests a trip to the airport, the transit service can receive the passenger's luggage and, after dropping off the passenger at the terminal, deliver the luggage to a baggage handler. In another example, a business traveler might deplane and wish to go to meetings before going to his or her hotel. The transit service can drop off the traveler at the meetings and then deliver the luggage to the hotel. The transit service can generate a trip solely to deliver the item, regardless of the delivery aligning with other routes or passenger trips.

In some embodiments, the transit service receives the item from the passenger and then delivers the item back to the passenger at a later time. For example, a passenger might commute partway on bicycle and finish their commute with the transit service. The transit service can then receive the bicycle when it picks up the passenger and then deliver the bicycle to the passenger when the passenger takes the next trip. This next trip could be a return trip of the commute. Alternatively, the next trip can be to another destination or from another part of town than where the transit service initially dropped off the passenger.

In some embodiments, the transit service can also have a storage center for storing items. A passenger can then store items at the storage center and have them available on request, deliverable as the passenger uses the transit service. For example, a sales representative can keep product at the storage center and, when the sales representative requests a trip, he or she can request an amount of product to be delivered to him or her (e.g., as the representative go to a sales meeting).

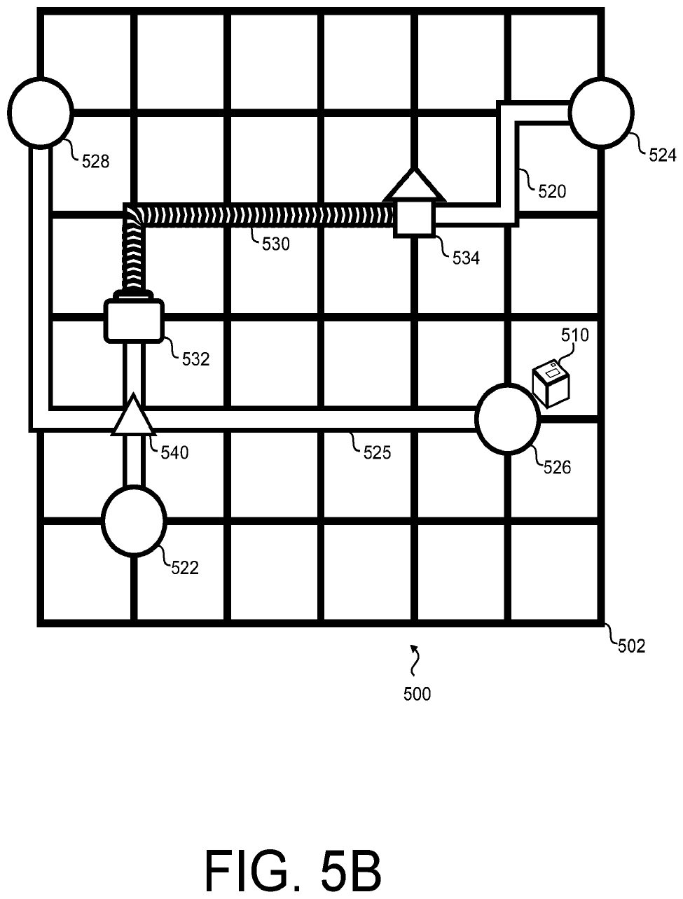

FIGS. 5A, 5B, and 5C illustrate example approaches to provide an item to a passenger while servicing a trip for the passenger. For example, in example city map 500 of FIG. 5A, the passenger can request a trip 530 from origin 532 to destination 534. A transit service can have a vehicle that services route 520 between point 522 and point 524. An item 510 for delivery to the passenger can be at location 522. The transit service can determine that route 520 services trip 530 and can load item 510 into a vehicle for that route. The vehicle can effect delivery of item 510 when the vehicle gets to the passenger at origin 532, when the vehicle and passenger arrive at destination 534, or anywhere in between.

The passenger can have a delivery service leave item 510 at point 522. For example the passenger might purchase the item at an online retailer and can identify point 522 as the delivery address. Point 522 can be a transit hub where many routes connect. The transit service can then identify item 510 and determine that item 510 should be delivered to the passenger. The passenger, the online retailer, or the national delivery service can inform the transit service that item 510 should be delivered to the passenger. The transit service can then hold onto item 510 until it finds an opportunity to delivery item 510 to the passenger when the passenger requests trip 530.

In situations where item 510 and trip 530 do not share a route, the transit service can send item 510 with another vehicle servicing another route to bring item 510 to the route that services trip 530. For example, in example map 550 in FIG. 5B, the transit service can place item 510 on a vehicle servicing route 525 going from point 526 to point 528. At transfer point 540, the transit service can move item 510 from the vehicle servicing route 525 to a vehicle servicing route 520. In some embodiments, transfer point 540 is a “timed transfer” meaning the two vehicles are scheduled to be at the same stop at the same time and a driver moves item 510 from one vehicle to the other. Alternatively, the transit service can leave item 510 at transfer point 540 until the vehicle servicing route 520 passes by and the driver of that vehicle can retrieve item 510 for delivery. In some such embodiments, transfer point 540 can be a storage locker, room, building, etc. and can have adequate security to protect item 510 during the transfer process. The transit service can inform the driver of route 525 that the driver needs to leave item 510 at transfer point 540 and the transit service can inform the driver of route 520 that the drive needs to retrieve item 510 at transfer point 540. The transit service can determine when the vehicle that will service trip 530 will be at transfer point 540; the transit service can then determine a vehicle that can deliver item 510 from point 526 to transfer point 540 before the other vehicle gets to transfer point 540. In some embodiments, route 525 is exclusive to deliver items to transfer points and does not provide rides to passengers. Alternatively, route 525 can provide rides to passengers as well as carry items.

In some embodiments, trip 530 is serviced by a combination of two routes. For example, in example map 580 in FIG. 5C, route 525 and route 530 service trip 530. The transit service can pick up the passenger at origin 532, the passenger then transfers from route 525 to route 530 at transfer point 540, and the transit service drops off the passenger at destination 534. Transit service can effect delivery at origin 532, transfer point 540, destination 534, or anywhere in between.

The transit service can select a delivery location based on a size of item 510. For example, if item 510 is heavy the passenger might wish to receive the item at the end of trip 530 so that the passenger does not need to carry the item while in transit which can be uncomfortable or dangerous. Similarly, if the volume of item 510 makes it better suited for cargo storage in the vehicle the transit service can effect delivery at destination 534. The transit service can determine that item 510 is small enough for the passenger to easily carry item 510 during their trip, including any necessary transfers. The transit service can determine that origin 532 can be the delivery location. In some embodiments, scheduling constraints can inform selection of a delivery location. For example, the transit service can determine that route 525 has a tight schedule and that any delay caused by delivering item 510 might throw off the schedule; it can then determine that the delivery location should be along route 520 if route 520 has a schedule that affords time for delivery. In some embodiments, the passenger can specify a preference for the delivery location. For example the passenger can specify that they prefer to receive item 510 at origin 532 (to give the passenger opportunity to enjoy item 510 during trip 530) or at destination 534 (so that the passenger does not need to carry item 510 during trip 530).

In some embodiments, the transit service can decide where item 510 is loaded onto a vehicle. For example, the transit service can have storage locations at point 522 and point 526. Based on the capacity or scheduling of the vehicles servicing route 525 and route 520 or based on the preference of the passenger, the transit service can deposit item 510 at the appropriate location. For example, if the vehicle that services route 525 has limited capacity (or is expected to have limited capacity), the transit service can deposit item 510 at location 522 so that item 510 can be later placed in the vehicle servicing route 520 for delivery along route 520.

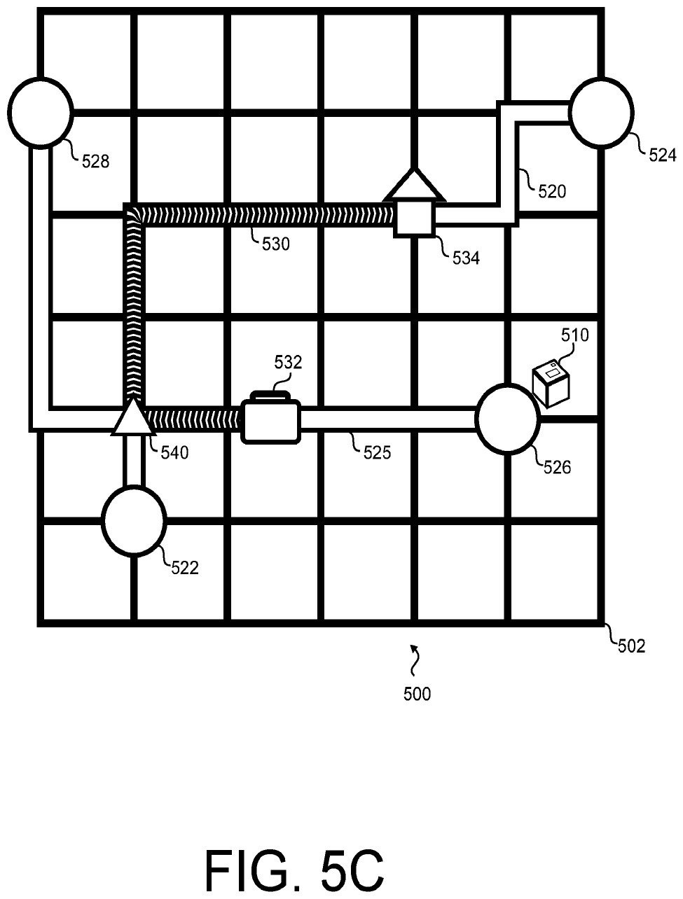

As shown in FIGS. 6A, 6B, and 6C, the transit service can place item 510 on a specific seat of a vehicle. As shown on example portable electronic device 600 of FIG. 6A, user interface 601 can indicate that a passenger's ride is approaching (e.g., the vehicle that will service trip 530). User interface 601 can indicate a specific seat where item 510 is located. In some embodiments, the transit service determines that the seat will be available for a period of time (e.g., a certain number of stops, based on expected ridership information) before the passenger enters the vehicle. At a point of time during that period of time, the transit service can place (e.g., by instructing the driver) item 510 in that seat. The item can be placed in an area associated with the seat such as an overhead bin, a seatback pocket, etc.

FIG. 6B illustrates an example security mechanism for securing item 510 during transit before delivery. To prevent theft of tampering with item 510 during transit by other passengers, a security mechanism can secure item 510 to the vehicle. For example, item 510 can be placed on seat 602. Seat belt 604 can be inserted into buckle 606. Buckle 606 can then lock. FIG. 6C illustrates disengaging the example security mechanism.

The security mechanism can be a compartment attached to the vehicle, a cubby, a security strap as shown in FIGS. 6B and 6C, etc. The security mechanism can be an alarm. For example, the item can be placed with a sensor that will go off if the item is inappropriately removed.

To disengage the security mechanism, the transit service can determine that the passenger is close to the item. For example, a phone associated with the passenger can detect its location using GPS and then notify the transit service of its location. The transit service can then compare the passenger's location with the location of the item to determine that the passenger is near the item. The transit service can determine the item's location by tracking the location of the associated vehicle. In some embodiments, the transit service disengages the security mechanism based on the vehicle's location; for example, if the vehicle has arrived at the delivery location. In some embodiments, the transit service sends a code to the passenger which can be used to disengage the security mechanism. For example, the passenger could enter the code into the security mechanism or can present the code (e.g., as a QR code displayed on a cell phone) to the security mechanism. In some embodiments, the passenger has a ticket (physical or digital) authorizing the passenger to ride with the transit service; in some such embodiments, the ticket can also prove that the passenger is ready to receive the item (and disengage the security mechanism).

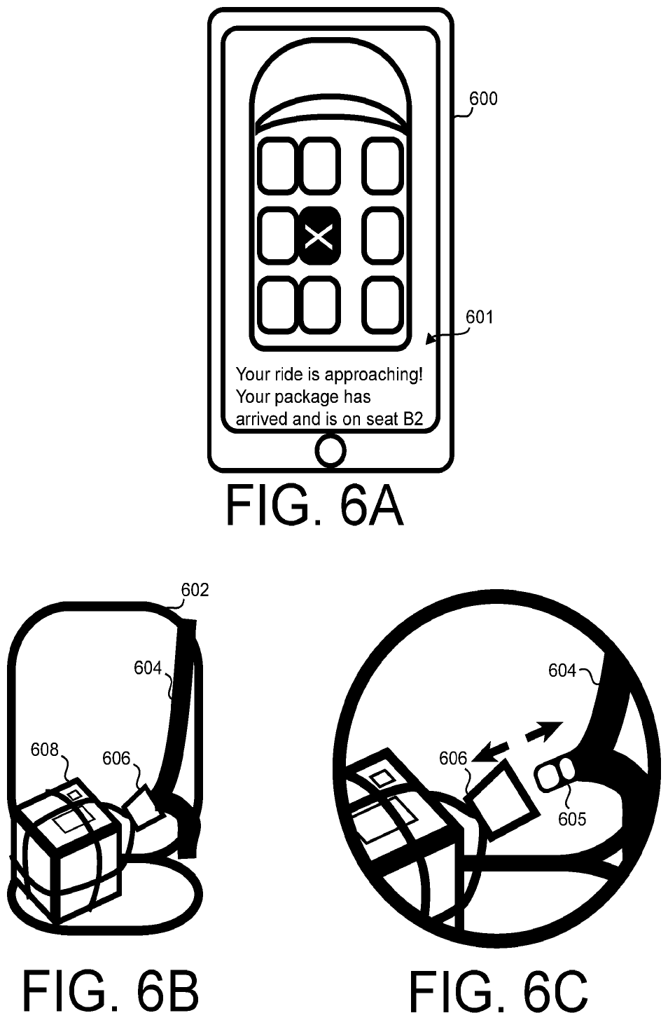

FIG. 7 illustrates an example technique for receiving an item. A passenger can use a portable electronic device 700 to scan the item (as shown in display 702). The portable electronic device 700 can then notify the transit service that the passenger has received or is ready to receive the item. The transit service can then disable any security mechanism. In some embodiments, the personal electronic device 700 can notify or remind the passenger that the item is available for receiving. For example, a system can determine that the passenger is nearby the delivery location; it can then present the notification or reminder (e.g., “don't forget your package!”). The portable electronic device 700 can then have a selectable button that would bring up display 702 for scanning and receiving the item.

In some embodiments, authenticated delivery is required. For example, the passenger can be required to “sign” for a package. The passenger can “sign” (or otherwise authenticate) a screen on their portable electronic device confirming receipt. Alternatively or additionally, the vehicle can take a picture of the passenger receiving the item. Other forms of authentication such as biometrics can be used.

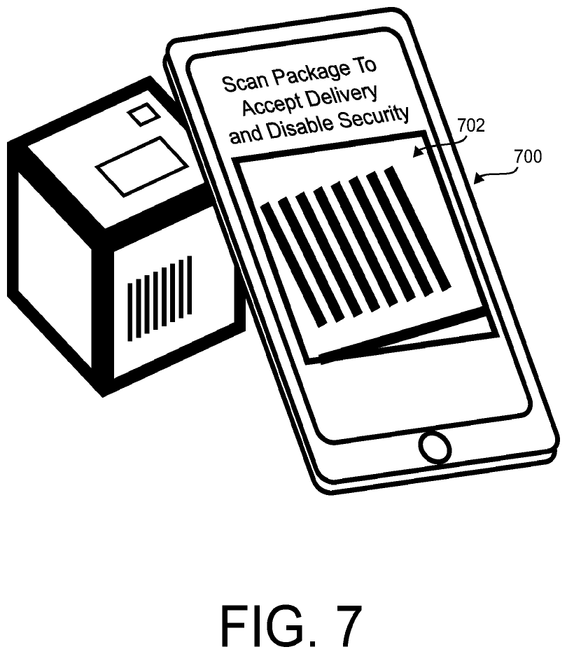

FIG. 8 illustrates an example vehicle layout 800 for putting passengers and items into a vehicle. In some embodiments, items can be placed on seats of a vehicle like as shown in FIGS. 6A-6C. Alternatively or additionally, the vehicle can be configurable so as to provide more room for items if necessary. For example, unneeded seats can fold down, fold into the bottom of the vehicle, or be removed. Turning to example vehicle layout 800, seats 702ₐ, 702_{b}, 702_{c}, and 702_{f} can be reserved for passengers, while seats (or locations) 702_{g}, 702ₕ, and 702ᵢ, can be reserved for items. Seats 702_{d} and 702ₑ can be used for either passengers or items. The transit service can predict a total capacity of a vehicle (e.g., the number of seats) and can then determine the anticipated ridership for the vehicle. The transit service can then configure the vehicle appropriately by adding, removing, or reconfiguring seating. For example, if a vehicle has 12 seats and the expected maximum concurrent ridership is 9 passengers, three seats can be removed. The transit system can dynamically adjust capacity along a route as passenger requirements fluctuate.

In some embodiments additional devices or mechanisms can be used for package transport as well. For example, a package might require delivery to a rider on a particular route, but the package is unable to be placed on the vehicle before the route begins. This may be due to timing of the delivery vehicle, or unavailability of the information before the route stated, among other such options. In such instances, the transport vehicle including the passenger may have a mechanism such as a landing pad or drone dock that can receive a delivery vehicle, such as a drone or unmanned autonomous vehicle, that is transporting a package or parcel for delivery. The delivery vehicle may be able to deliver the package to the vehicle, whereby the target recipient can retrieve the package upon exiting the vehicle. There may be some vehicles where the package may be able to be moved inside the vehicle while in motion, such as through a conveyor system or robotics. A similar process can be used to enable a passenger to send a package or parcel while the transport vehicle is in motion, whereby the drone or other vehicle can obtain the item from the appropriate pad or dock, etc.

Such an approach can also enable a passenger to order or obtain items while in transit. For example, a customer might use a mobile app to order food, coffee, or a magazine. The customer can indicate the current vehicle, or the vehicle information can be obtained automatically, and an order can be placed to be delivered to the vehicle. Upon delivery to a dock or other mechanism, the item(s) can be transferred to the interior of the vehicle, enabling a customer to obtain food, drink, or merchandise while on the vehicle without a need to stop, detour, or otherwise delay the vehicle. In some embodiments items may not be able to be delivered or received while in motion or on certain streets, but may be able to be transferred at stop lights or at certain stops along the current route, among other such options.

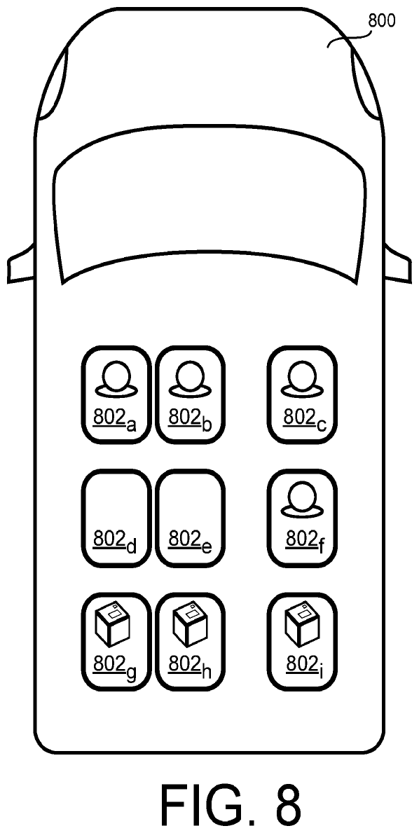

FIG. 9 illustrates an example trip request screen 902 on a personal electronic device 600. A passenger can request a trip (e.g., from “your location” to “523 C Street”). The transit service can then determine a route (or routes) that can service the requested trip. A route servicing the trip might also pass by retailers, restaurants, etc. that offer things for purchase. For example, turning to FIG. 5A, a bakery can be located at point 522. The store need not be located before the passenger's destination. For example, in FIG. 5A an electronics store can be at point 524. The vehicle servicing route 520 that is anticipated to service the passenger's trip can pick up an electronics item at the store when it does a round on route 520 at a prior time. Because different routes pass by different shops, the available items for purchase and delivery can vary by trip. The system can determine which routes service the trip and which stores are along those routes. The system can then determine which items would be available at those stores and present them as selectable items on request screen 902. In some embodiments, items for purchase can have a preparation time indicating how long it will take for the store to prepare the item. The transit service can calculate when the selected vehicle will pass by the store and if the item would be ready based on the preparation time. If the vehicle is a long distance train, this can be beneficial to passengers that would like a meal that is not otherwise available on the train. For example, a passenger of a train from San Jose to Los Angeles might want a hamburger from a favorite restaurant in San Francisco. The restaurant can deliver the hamburger to the train which can then have it available for the passenger to pick up on the train at their convenience. Similarly, a take-out restaurant can provide a meal to a car for hire as it travels to pick up the passenger.

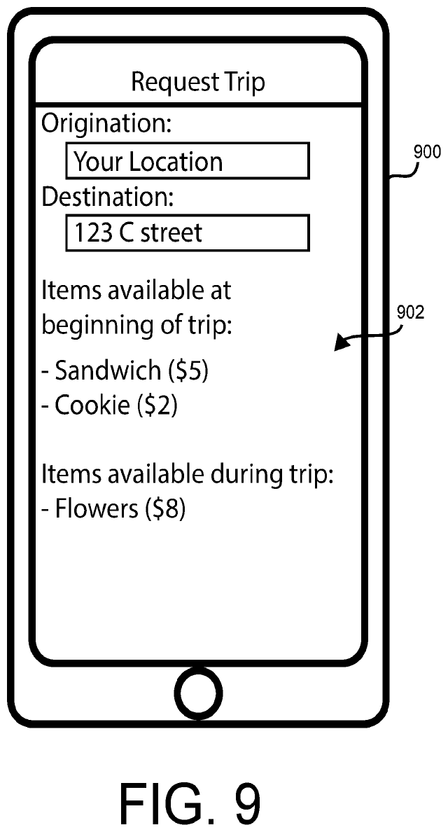

FIG. 10 illustrates an example computing device 1000 that can be used in accordance with various embodiments. Although a portable computing device (e.g., a smart phone or tablet computer) is shown, it should be understood that any device capable of receiving, processing, and/or conveying electronic data can be used in accordance with various embodiments discussed herein. The devices can include, for example, desktop computers, notebook computers, smart devices, Internet of things (IoT) devices, video gaming consoles or controllers, wearable computers (e.g., smart watches, glasses, or contacts), television set top boxes, and portable media players, among others. In this example, the computing device 1000 has an outer casing 1002 covering the various internal components, and a display screen 1004 such as a touch screen capable of receiving user input during operation of the device. These can be additional display or output components as well, and not all computing devices will include display screens as known in the art. The device can include one or more networking or communication components 1006, such as may include at least one communications subsystem for supporting technologies such as cellular communications, Wi-Fi communications, BLUETOOTH® communications, and so on. There may also be wired ports or connections for connecting via a land line or other physical networking or communications component.

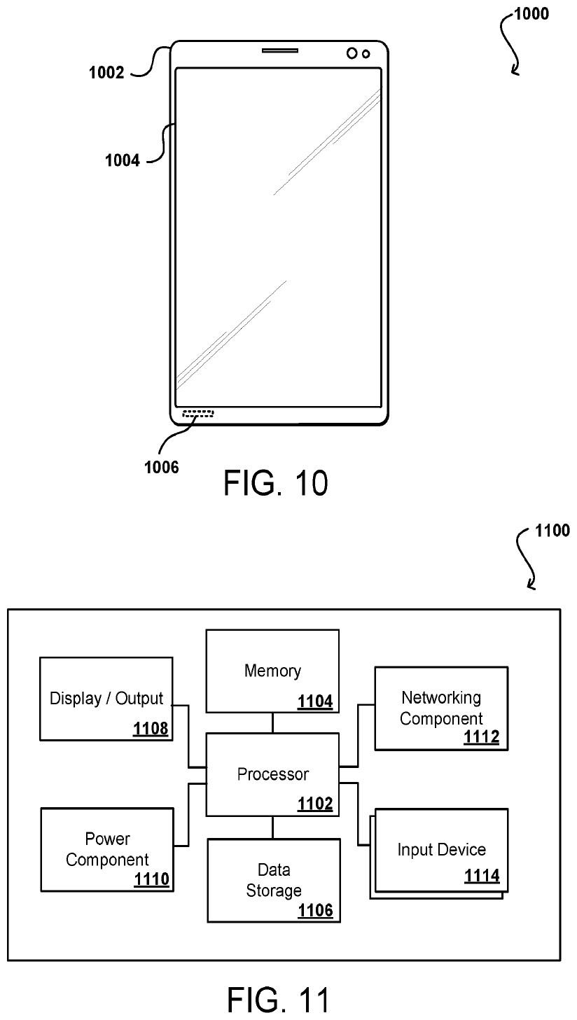

FIG. 11 illustrates an example set of components that can comprise a computing device 1100 such as the device described with respect to FIG. 10, as well as computing devices for other purposes such as application servers and data servers. The illustrated example device includes at least one main processor 1102 for executing instructions stored in physical memory 1104 on the device, such as dynamic random-access memory (DRAM) or flash memory, among other such options. As would be apparent to one of ordinary skill in the art, the device can include many types of memory, data storage, or computer-readable media as well, such as a hard drive or solid state memory functioning as data storage 1106 for the device. Application instructions for execution by the at least one processor 1102 can be stored by the data storage 1106 then loaded into memory 1104 as needed for operation of the device 1100. The processor can also have internal memory in some embodiments for temporarily storing data and instructions for processing. The device can also support removable memory useful for sharing information with other devices. The device will also include one or more power components 1110 for powering the device. The power components can include, for example, a battery compartment for powering the device using a rechargeable battery, an internal power supply, or a port for receiving external power, among other such options.

The computing device may include, or be in communication with, at least one type of display element 1108, such as a touch screen, organic light emitting diode (OLED), or liquid crystal display (LCD). Some devices may include multiple display elements, as may also include LEDs, projectors, and the like. The device can include at least one communication or networking component 1112, as may enable transmission and receipt of various types of data or other electronic communications. The communications may occur over any appropriate type of network, such as the Internet, an intranet, a local area network (LAN), a 5G or other cellular network, or a Wi-Fi network, or can utilize transmission protocols such as BLUETOOTH® or NFC, among others. The device can include at least one additional input device 1114 capable of receiving input from a user or other source. This input device can include, for example, a button, dial, slider, touch pad, wheel, joystick, keyboard, mouse, trackball, camera, microphone, keypad, or other such device or component. Various devices can also be connected by wireless or other such links as well in some embodiments. In some embodiments, a device might be controlled through a combination of visual and audio commands, or gestures, such that a user can control the device without having to be in contact with the device or a physical input mechanism.

Much of the functionality utilized with various embodiments will be operated in a computing environment that may be operated by, or on behalf of, a service provider or entity, such as a rideshare provider or other such enterprise. There may be dedicated computing resources, or resources allocated as part of a multi-tenant or cloud environment. The resources can utilize any of a number of operating systems and applications, and can include a number of workstations or servers Various embodiments utilize at least one conventional network for supporting communications using any of a variety of commercially-available protocols, such as TCP/IP or FTP, among others. As mentioned, example networks include for example, a local area network, a wide-area network, a virtual private network, the Internet, an intranet, and various combinations thereof. The servers used to host an offering such as a ridesharing service can be configured to execute programs or scripts in response requests from user devices, such as by executing one or more applications that may be implemented as one or more scripts or programs written in any appropriate programming language. The server(s) may also include one or more database servers for serving data requests and performing other such operations. The environment can also include any of a variety of data stores and other memory and storage media as discussed above. Where a system includes computerized devices, each such device can include hardware elements that may be electrically coupled via a bus or other such mechanism. Example elements include, as discussed previously, at least one central processing unit (CPU), and one or more storage devices, such as disk drives, optical storage devices and solid-state storage devices such as random access memory (RAM) or read-only memory (ROM), as well as removable media devices, memory cards, flash cards, etc. Such devices can also include or utilize one or more computer-readable storage media for storing instructions executable by at least one processor of the devices. An example device may also include a number of software applications, modules, services, or other elements located in memory, including an operating system and various application programs. It should be appreciated that alternate embodiments may have numerous variations from that described above.

Various types of non-transitory computer-readable storage media can be used for various purposes as discussed and suggested herein. This includes, for example, storing instructions or code that can be executed by at least one processor for causing the system to perform various operations. The media can correspond to any of various types of media, including volatile and non-volatile memory that may be removable in some implementations. The media can store various computer readable instructions, data structures, program modules, and other data or content. Types of media include, for example, RAM, DRAM, ROM, EEPROM, flash memory, solid state memory, and other memory technology. Other types of storage media can be used as well, as may include optical (e.g., Blu-ray or digital versatile disk (DVD)) storage or magnetic storage (e.g., hard drives or magnetic tape), among other such options. Based on the disclosure and teachings provided herein, a person of ordinary skill in the art will appreciate other ways and/or methods to implement the various embodiments.

The specification and drawings are to be regarded in an illustrative sense, rather than a restrictive sense. It will, however, be evident that various modifications and changes may be made thereunto without departing from the broader spirit and scope of the various embodiments as set forth in the claims.

What is claimed is:

1. A computer-implemented method, comprising:
receiving an item to be delivered to a recipient;
determining a trip request corresponding to future transport of the recipient;
identifying a vehicle to be used for the future transport of the recipient;
causing the item to be placed in the vehicle; and
enabling the recipient to receive the item from the vehicle at a time corresponding to the future transport.

2. The computer-implemented method of claim 1, further comprising:
engaging a security mechanism to secure the item in the vehicle;
determining that the recipient is physically proximate the item; and
causing the security mechanism to disengage, wherein the recipient is able to obtain the item.

3. The computer-implemented method of claim 1, further comprising determining that the vehicle has arrived at a destination for the trip request, wherein enabling the recipient to receive the item is based on the determination that the vehicle has arrived at the destination.

4. The computer-implemented method of claim 1, further comprising:
receiving a message from a portable electronic device associated with the passenger, the message indicating receipt of the item and including at least one of the following:
an identifier associated with the item; or
a location of the portable electronic device.

5. The computer-implemented method of claim 1, further comprising placing the item at a storage location along a route, the route being serviced by the vehicle, wherein causing the item to be placed in the vehicle includes causing the item to be retrieved from the storage location.

6. The computer-implemented method of claim 1, further comprising:
determining an assigned seat for the passenger;
causing the item to be placed at the assigned seat; and
notifying the passenger that the item is at the assigned seat.

7. The computer-implemented method of claim 1, further comprising:
receiving a second trip request; and
wherein the receiving of the item occurs while servicing the second trip request.

8. The computer-implemented method of claim 1, further comprising:
identifying a second vehicle capable of being used for the future transport of the recipient and the item.
determining a first capacity of the vehicle;
determining a second capacity of the second vehicle; and
determining that the first vehicle or the second vehicle is optimal for providing the item to the passenger based on the first capacity and the second capacity.

9. The computer-implemented method of claim 1, further comprising:
determining that the vehicle can change from a first configuration to a second configuration, the second configuration having a greater capacity to hold items than the first configuration; and
causing the vehicle to be modified for the second configuration.

10. The computer-implemented method of claim 1, further comprising:
determining a capacity of the vehicle;
determining a capacity of a second vehicle capable of being used for the future transport of the recipient, the second vehicle being associated with a route that is distinct from the vehicle;
wherein identifying the vehicle to be used for the future transport of the recipient comprises:
comparing the capacity of the vehicle and the capacity of the second vehicle, yielding a comparison; and
determining, based on the comparison, that the vehicle is optimal for receiving the item while servicing the least a portion of the trip request.

11. The computer-implemented method of claim 1, wherein causing the item to be placed in the vehicle includes receiving the item from an autonomous delivery vehicle during transport of the passenger

12. A computer-implemented method comprising:
receiving a trip request for a passenger, the trip request corresponding to future transport of the passenger;
receiving, from the passenger, a shipment request to ship an item;
receiving the item at the vehicle from the passenger during the future transport; and
causing the item to be delivered to a recipient.

13. The computer-implemented method of claim 12, further comprising causing the item to be placed at a storage location along a route, the route being serviced by the vehicle.

14. The computer-implemented method of claim 13, further comprising:
determining a pickup location for the passenger;
determining that the vehicle has arrived at the pickup location; and
sending a notification to a driver of the vehicle, the notification indicating that the passenger has a package for shipment.

15. The computer-implemented method of claim 12, further comprising:
identifying a second vehicle will service a portion of the trip request;
determining a first capacity of the vehicle;
determining a second capacity of the second vehicle; and
determining that the vehicle is optimal for providing the item to the passenger based on the first capacity and the second capacity.

16. The computer-implemented method of claim 12, further comprising:
receiving a second trip request from the recipient, the second trip request corresponding to future transport of the recipient; and
providing transport to the recipient, wherein the item is delivered to the recipient while providing transport.

17. A system, comprising:
a vehicle configured to transport at least one item and to transport at least one passenger;
at least one processor; and
memory including instructions that, when executed by the at least one processor, cause the system to:
receive a trip request for a passenger, the trip request corresponding to future transport of the passenger;
receive, from the passenger, a shipment request to ship an item;
receive the item at the vehicle from the passenger during the future transport; and
cause the item to be delivered to a recipient.

18. The system of claim 17, wherein the instructions when executed further cause the system to:
determine a pickup location for the passenger;
determine that the vehicle has arrived at the pickup location; and
send a notification to a driver of the vehicle, the notification indicating that the passenger has a package for shipment.

19. The system of claim 17, wherein the instructions when executed further cause the system to:
identify a second vehicle will service a portion of the trip request;
determine a first capacity of the vehicle;
determine a second capacity of the second vehicle; and
determine that the vehicle is optimal for providing the item to the passenger based on the first capacity and the second capacity.

20. The system of claim 17, wherein the instructions when executed further cause the system to:
receive a second trip request from the recipient, the second trip request corresponding to future transport of the recipient; and
provide transport to the recipient, wherein the item is delivered to the recipient while providing transport.
